(19) United States
(12) Patent Application Publication
(10) Pub. No.: US 2016/0090270 A1
(43) Pub. Date: Mar. 31, 2016

(54) DEVICE TRIGGERED ELEVATOR CAR CALL

(71) Applicant: OTIS ELEVATOR COMPANY, Farmington, CT (US)

(72) Inventor: Ying Wang, Shanghai (CN)

(21) Appl. No.: 14/892,315

(22) PCT Filed: May 21, 2013
(86) PCT No.: PCT/CN2013/075971

§ 371 Date: Nov. 19, 2015

(51) Int. Cl. B66B 1/46

(52) U.S. Cl. CPC B66B 1/468; B66B 2201/4615; B66B 2201/4653; B66B 2201/4676

(57) ABSTRACT

Embodiments are directed to establishing, by at least one panel of an elevator system, communication with a user device comprising at least one of a cell phone, a smartphone, a PDA, and a laptop computer, receiving, by the at least one panel, an identifier associated with the user device based on the established communication, receiving, by the at least one panel, a selection of a destination floor, and associating, by the at least one panel, the identifier with the destination floor.

### BACKGROUND

Occupants of a multi-level or multi-story building may tend to repeatedly go to the same location. For example, people working in a high rise office building may take an elevator car from the ground floor (e.g., the lobby) to a destination floor or landing corresponding to an employer's floor or location within the building. The people may take the elevator car to the employer's floor or location at approximately the same time each day.

To accommodate elevator use, a “two-button” or “two-interface” solution may be provided where a person first enters a first command on a hall input device signifying a request for service and potentially a desired direction of travel (e.g., up/down). Once an elevator car arrives, the person may enter an elevator car and depress a button associated with a floor of the building located inside the elevator car to select a destination floor. Alternatively, a “one-button” or “one-interface” solution may be provided, where a person may enter both a request for service and a destination floor on a single device (e.g., a kiosk located in the lobby of the building).

### BRIEF SUMMARY

An embodiment is directed to a method comprising: establishing, by at least one panel of an elevator system, communication with a user device comprising at least one of a cell phone, a smartphone, a PDA, and a laptop computer, receiving, by the at least one panel, an identifier associated with the user device based on the established communication, receiving, by the at least one panel, a selection of a destination floor, and associating, by the at least one panel, the identifier with the destination floor.

An embodiment is directed to an apparatus comprising: at least one processor, and memory having instructions stored thereon that, when executed by the at least one processor, cause the apparatus to: establish communication with a user device comprising at least one of a cell phone, a smartphone, a PDA, and a laptop computer, receive an identifier associated with the user device based on the established communication, receive a selection of a destination floor associated with an elevator system, and associate the identifier with the destination floor.

An embodiment is directed to a system comprising: an elevator system comprising at least one panel configured to: receive a selection of a destination floor, and associate an identifier with the destination floor, and a user device comprising at least one of a cell phone, a smartphone, a PDA, and a laptop computer, the user device configured to: establish communication with the at least one panel, and transmit the identifier based on the established communication.

Additional embodiments are described below.

### BRIEF DESCRIPTION OF THE DRAWINGS

The present disclosure is illustrated by way of example and not limited in the accompanying figures in which like reference numerals indicate similar elements.

FIG. 1 is a schematic block diagram illustrating an exemplary computing system in accordance with one or more aspects of this disclosure;

FIG. 2 illustrates an exemplary block diagram in accordance with one or more embodiments; and

FIG. 3 illustrates a flow chart of an exemplary method in accordance with one or more embodiments.

### DETAILED DESCRIPTION

It is noted that various connections are set forth between elements in the following description and in the drawings (the contents of which are included in this disclosure by way of reference). It is noted that these connections in general and, unless specified otherwise, may be direct or indirect and that this specification is not intended to be limiting in this respect. In this respect, a coupling between entities may refer to either a direct or an indirect connection.

Exemplary embodiments of apparatuses, systems, and methods are described for determining a destination floor or landing for an elevator car. In some embodiments, the destination floor may be determined based on a user device associated with a passenger of the elevator. An identifier associated with the user device or the owner of the user device may be associated with a particular floor of the building. The association between the user device or the owner of the user device, and the particular floor may be based on communication between the user device and panel of the elevator.

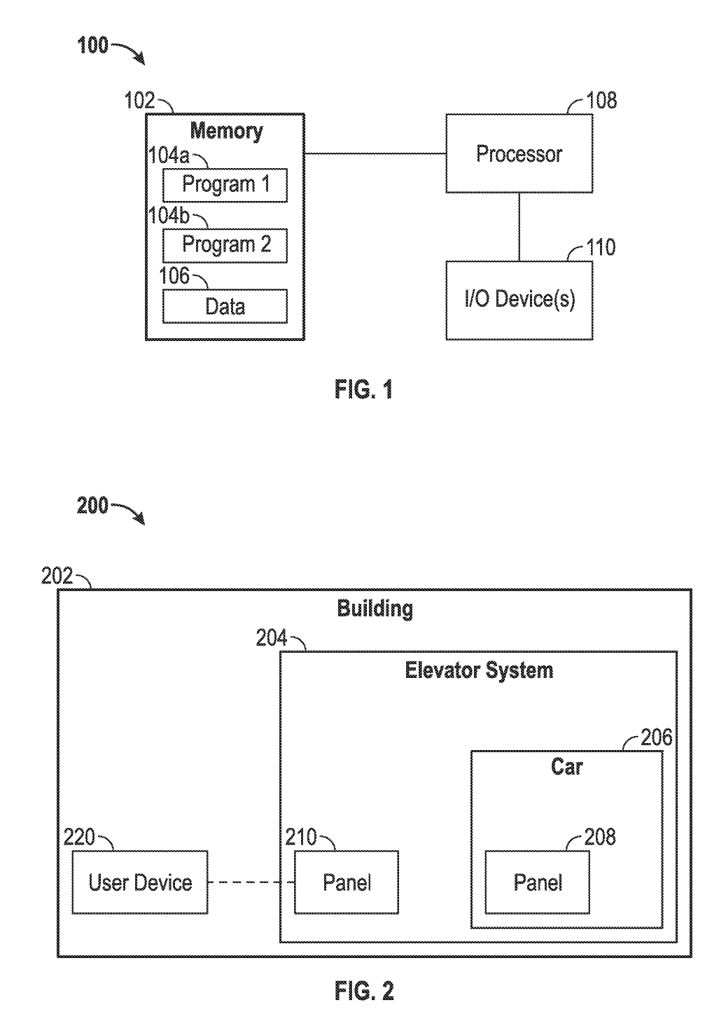

Referring now to FIG. 1, an exemplary computing system 100 is shown. The system 100 is shown as including a memory 102. The memory 102 may store executable instructions. The executable instructions may be stored or organized in any manner and at any level of abstraction, such as in connection with one or more applications, processes, routines, procedures, methods, etc. As an example, at least a portion of the instructions are shown in FIG. 1 as being associated with a first program 104a and a second program 104b.

The memory 102 may store data 106. The data 106 may include data associated with a user device, such as a cell phone. The data 106 may include a floor number associated with the user device.

The instructions stored in the memory 102 may be executed by one or more processors, such as a processor 108. The processor 108 may be operative on the data 106.

The processor 108 may be coupled to one or more input/output (I/O) devices 110. In some embodiments, the I/O device(s) 110 may include one or more of a keyboard or keypad, a touchscreen or touch panel, a display screen, a microphone, a speaker, a mouse, a button, a remote control, a joystick, a printer, etc. The I/O device(s) 110 may be configured to provide an interface to allow a user to interact with the system 100.

The system 100 is illustrative. In some embodiments, one or more of the entities may be optional. In some embodiments, additional entities not shown may be included. For example, in some embodiments the system 100 may be associated with one or more networks, such as one or more computer or telephone networks. In some embodiments, the entities may be arranged or organized in a manner different from what is shown in FIG. 1.

Turning now to FIG. 2, an exemplary block diagram 200 in accordance with one or more embodiments is shown. The block diagram 200 is shown as including a building 202. In some embodiments, the building 202 may be an office building. The building 202 may include a number of floors. Persons entering the building 202 may enter at a lobby floor, and may go to a destination floor via one or more conveyance devices. For example, an elevator system 204 may be used to travel to the destination floor.

The elevator system 204 may include one or more elevator cars, such as a car 206. The car 206 may be configured to traverse a shaft or hoistway (not shown) associated with the elevator system 204.

The car 206 may include one or more panels, such as a panel 208. The panel 208 may correspond to a car operation panel (COP). The panel 208 may be used to communicate with one or more devices, such as a user device 220, to determine a destination floor for the owner/bearer of the devices/user device, as described in further detail below.

The elevator system 204 may include a panel 210. The panel 210 may correspond to a hall operation panel (HOP). In some embodiments, an instance of the panel 210 may be located on every floor of the building 202. In some embodiments, the panel 210 may be located on a single floor (e.g., on a ground floor in a lobby of the building 202, potentially implemented in connection with a kiosk). The panel 210 may be used to request service from the elevator system 204. For example, the panel 210 may be used to summon an elevator car. The request for service may be based on communication between the panel 210 and one or more devices, such as the user device 220.

Without limitation, the user device 220 may include one or more of a cell phone, a smartphone, a PDA, a laptop computer, etc. The user device 220 may be a device associated with a user or passenger of the elevator system 204. The user/passenger may frequently have the user device 220 in his/her possession. The user device 220 may be used for purposes other than conveyance within a conveyance system (e.g., an elevator system).

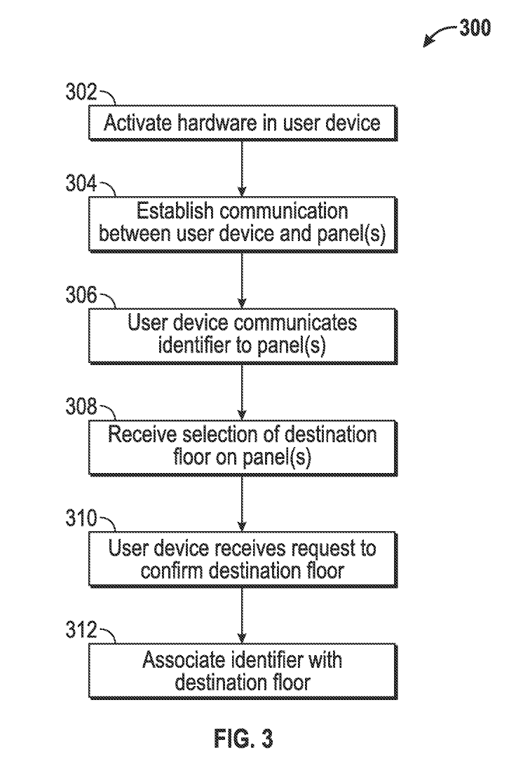

As described above, the communication between the panel 208 or 210 and the user device 220 may be used/leveraged for determining a destination floor for the user device 220's owner. FIG. 3 illustrates a method 300 that may be used to establish the destination floor.

In block 302, the owner may, in the user device 220, turn-on or activate hardware that may communicate with the panel 210 and/or the panel 208, before the first time the owner of the user device 220 approaches the elevator system 204.

In block 304, once the owner of the user device 220 is proximate to the panel 210 and/or the panel 208 which may be scanning/detecting for any devices coming into its detection range. The panel 210 or 208 may establish communication with the user device 220. The communication may occur using one or more communication techniques, standards, or protocols. For example, infrared communication, Bluetooth communication, near-field communication (NFC), etc., may be used.

In block 306, once an inquiry from the panel 210 or 208 is received, the user device 220 may automatically communicate an identifier associated with the user device 220 to the panel 210 and/or the panel 208. For example, if Bluetooth is activated on the user device 220, a Bluetooth ID associated with the user device 220 may be communicated to the panel 210 and/or the panel 208. Alternatively, the identifier may correspond to a username that may be established by the owner of the user device 220.

In block 308, if the owner of the user device 220 has never approached or used the elevator system 204, and has never entered the elevator car of the elevator system 204, the owner of the user device 220 may enter a destination floor on the panel 210 and/or the panel 208.

In block 310, the user device 220 may receive (from, e.g., the panel 210 and/or the panel 208) a request to confirm that the destination floor entered in block 308 is intended to serve as a destination floor to be associated with the user device 220.

Only if the owner of the user device 220 confirms the request of block 310 (by Sending back a confirming message (such as “Yes/Y”) from the user device 220 to the panel 210 or 208), in block 312, the identifier of block 306 may be associated (by, e.g., the computing system 100) with the destination floor of block 308. In the future, when the owner of the user device 220 approaches the elevator system 204 again, the owner of the user device 220 might not need to specify, input, or indicate a destination floor by pressing call buttons on any hall/car call button panels. Instead, automatic communication of the identifier from the user device 220 to the panel 210 and/or panel 208 may serve to identify the user device 220 to the panel(s), and the association (block 312) between the identifier and the destination floor may serve to select the destination floor for the owner of the user device 220.

The method 300 is illustrative. In some embodiments, one or more of the blocks or operations (or portions thereof) may be optional. In some embodiments, additional operations not shown may be included. In some embodiments, the operations (or portions thereof) may execute in an order or sequence different from what is shown.

Once an identifier of a user device 220 is associated with a destination floor, that relationship may be maintained until the owner of the user device 220 selects a new destination floor to be associated with the user device 220/identifier. For example, the selection of the new destination floor may be made on the panel 210 and/or the panel 208, and in response to the received selection, the system 100 (in system 204) may, through the panel 208 or 210, send a request (such as a message) to the user device 220, asking the owner of the user device 220 to confirm the selection of the new destination floor. The request may be used to avoid changing the destination floor inadvertently, such as when the owner of the user device 220 is riding in the car 206 with a second passenger that is going to a different floor, where the second passenger entered her destination floor on, e.g., the panel 210 and/or the panel 208. The new destination floor may be confirmed and associated with the identifier of user device 220 (by overwriting the original destination floor) only when a positive response/feedback (such as a message says “yes”) has been sent back from the user device 220 to the panel 210 or 208, otherwise, the system 100 may keep the original association of the original destination floor and identifier, and ignore the new destination floor.

In some embodiments, an identifier associated with a user device 220 may be associated with more than one destination floor. For example, when the user device 220 requests elevator service in the morning, the destination floor associated with the user device 220 may be floor #5 (e.g., when the owner of the user device 220 first enters the building 202 to start her work day). Conversely, when the user device 220 requests elevator service in the afternoon, the destination floor associated with the user device 220 may be the ground floor (e.g., floor #1, so that the user can leave the building 202 at the end of the workday). Of course, more complex use cases may be established where the owner goes to different floors (e.g., floor #7, floor #3, floor #5) of the building at various points of the day (e.g., 10 AM, 10:30 AM, 11 AM), and the destination floor associated with the identifier may include each of the different floors at the different points of the day. The different destinations may be associated with the time of day or the address of the hall operating panel.

Additional features may be realized based on an ability to identify a user device 220. For example, the elevator system 204 may be able to tell the owner of the user device 220 how much he/she weighs each time she enters the car 206 or the elevator system 204 may be able to tell the owner of the user device 220 how long time he/she has worked each day (by calculating the time difference between the time when he or she took the elevator from floor-1 to floor-N and the time when he/she took the elevator from floor-N back to Floor-1), etc.

Embodiments of the disclosure may make an elevator easier to use. The cost of integrating communication hardware/software in one or more of the user device 220, the panel 210, and the panel 208 is expected to be much less than incorporating other user identification technologies, such as facial recognition technology, fingerprint identification technology, retinal scan technology, etc. For example, nowadays, most of the mobile devices (e.g., cell phones, PDAs, etc.) people use include a built-in Bluetooth module. If the Bluetooth is used as the communication interface between the user device 220 and the panel 210 or 208, then no additional software is needed to be installed in the user device. An elevator system may include the panel 210 or 208 integrated with a Bluetooth module and some customized software module (for detecting, scanning the approaching user devices (like user device 220) which are carried in the pocket by most of the passengers of the elevator system today, and for associating the identifier (like the Bluetooth ID of the user device 220) with the floor number input by the owner of the user device). This is especially meaningful, because any person with a user device (like a cell phone with Bluetooth) can have the different elevators (potentially made by different elevator manufacturers/brands who may have their own different hardware and/or software platforms for an elevator control system) informed on which floor the person wants to go, without manually pushing any call buttons for service.

Embodiments of the disclosure may be tied to one or more particular machines. For example, a user device (e.g., a mobile device) may communicate an identifier associated with the user device to one or more panels. The panel(s) may associate the identifier with a selected destination floor, such that future use of an elevator may, by default, take an owner of the user device to that destination floor. Such embodiments may be particularly useful in the event that the owner of the device has her hands full and cannot easily make a selection of a destination floor.

While some of the examples described herein related to elevator systems, aspects of this disclosure may be applied in connection with other types of conveyance devices, such as a dumbwaiter, an escalator, a moving sidewalk, a wheelchair lift, etc.

As described herein, in some embodiments various functions or acts may take place at a given location and/or in connection with the operation of one or more apparatuses, systems, or devices. For example, in some embodiments, a portion of a given function or act may be performed at a first device or location, and the remainder of the function or act may be performed at one or more additional devices or locations.

Embodiments may be implemented using one or more technologies. In some embodiments, an apparatus or system may include one or more processors, and memory storing instructions that, when executed by the one or more processors, cause the apparatus or system to perform one or more methodological acts as described herein. Various mechanical components known to those of skill in the art may be used in some embodiments.

Embodiments may be implemented as one or more apparatuses, systems, and/or methods. In some embodiments, instructions may be stored on one or more computer program products or computer-readable media, such as a transitory and/or non-transitory computer-readable medium. The instructions, when executed, may cause an entity (e.g., an apparatus or system) to perform one or more methodological acts as described herein.

Aspects of the disclosure have been described in terms of illustrative embodiments thereof. Numerous other embodiments, modifications and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional.

What is claimed is:

1. A method comprising:
establishing, by at least one panel of an elevator system, communication with a user device comprising at least one of a cell phone, a smartphone, a PDA, and a laptop computer;
receiving, by the at least one panel, an identifier associated with the user device based on the established communication;
receiving, by the at least one panel, a selection of a destination floor; and
associating, by the at least one panel, the identifier with the destination floor.

2. The method of claim 1, further comprising:
establishing, by the at least one panel, communication with the user device a second time subsequent to associating the identifier with the destination floor;
receiving, by the at least one panel, the identifier associated with the user device a second time based on the established communication the second time; and
causing an elevator car of the elevator system to be conveyed to the destination floor directly responsive to receiving the identifier associated with the user device the second time.

3. The method of claim 1, further comprising:
transmitting, by the at least one panel, a request to confirm the selection of the destination floor; and
receiving, by the at least one panel, a response to the request from the user device,
wherein the associating of the identifier with the destination floor is based on the response.

4. The method of claim 1, wherein the at least one panel comprises a hall operation panel located proximate to a hoistway of the elevator system.

5. The method of claim 1, wherein the at least one panel comprises a car operation panel located within an elevator car of the elevator system.

6. The method of claim 1, wherein the at least one panel is implemented in a kiosk on a ground floor of a building in which the elevator system is located.

7. The method of claim 1, wherein the communication is established using at least one of infrared communication, Bluetooth communication, and near-field communication (NFC).

8. The method of claim 1, wherein the identifier comprises a username established by an owner of the user device.

9. The method of claim 1, further comprising:
establishing, by the at least one panel, communication with the user device a second time subsequent to associating the identifier with the destination floor;
receiving, by the at least one panel, a selection of a second destination floor subsequent to establishing the communication with the user device the second time; and
associating, by the at least one panel, the identifier with the second destination floor.

10. An apparatus comprising:
at least one processor; and
memory having instructions stored thereon that, when executed by the at least one processor, cause the apparatus to:
establish communication with a user device comprising at least one of a cell phone, a smartphone, a PDA, and a laptop computer;
receive an identifier associated with the user device based on the established communication;
receive a selection of a destination floor associated with an elevator system; and
associate the identifier with the destination floor.

11. The apparatus of claim 10, wherein the instructions, when executed by the at least one processor, cause the apparatus to:
establish communication with the user device a second time subsequent to associating the identifier with the destination floor;
receive the identifier associated with the user device a second time based on the established communication the second time; and
cause an elevator car of the elevator system to be conveyed to the destination floor directly responsive to receiving the identifier associated with the user device the second time.

12. The apparatus of claim 10, wherein the instructions, when executed by the at least one processor, cause the apparatus to:
transmit a request to confirm the selection of the destination floor; and
receive a response to the request from the user device,
wherein the association of the identifier with the destination floor is based on the response.

13. The apparatus of claim 10, wherein the communication is established using Bluetooth communication, and wherein the identifier comprises a Bluetooth identifier.

14. The apparatus of claim 10, wherein the instructions, when executed by the at least one processor, cause the apparatus to:
establish communication with the user device a second time subsequent to associating the identifier with the destination floor;
receive a selection of a second destination floor subsequent to establishing the communication with the user device the second time; and
associate the identifier with the second destination floor.

15. The apparatus of claim 14, wherein the instructions, when executed by the at least one processor, cause the apparatus to:
overwrite the association of the identifier with the destination floor when associating the identifier with the second destination floor.

16. The apparatus of claim 10, wherein the instructions, when executed by the at least one processor, cause the apparatus to:
associate the identifier with the destination floor based on a first time of day; and
associate the identifier with a second destination floor based on a second time of day.

17. A system comprising:
an elevator system comprising at least one panel configured to:
receive a selection of a destination floor; and
associate an identifier with the destination floor; and
a user device comprising at least one of a cell phone, a smartphone, a PDA, and a laptop computer, the user device configured to:
establish communication with the at least one panel; and
transmit the identifier based on the established communication.

18. The system of claim 17, wherein the user device is configured to:
establish communication with the at least one panel a second time subsequent to the association of the identifier with the destination floor;
transmit the identifier a second time based on the established communication the second time; and
wherein the at least one panel is configured to:
cause an elevator car of the elevator system to be conveyed to the destination floor directly responsive to the transmission of the identifier the second time.
